(19) United States
(12) Patent Application Publication
(10) Pub. No.: US 2013/0258697 A1
(43) Pub. Date: Oct. 3, 2013

(54) POLYHEDRON TYPE LAMP FOR VEHICLE

(71) Applicant: Hiroshi Suzuki, Kanagawa (JP)

(72) Inventor: Hiroshi Suzuki, Kanagawa (JP)

(73) Assignees: Hyundai Motor Japan R&D Center Inc., Yokohama City (JP); Kia Motors Corporation, Seoul (KR); Hyundai Motor Company, Seoul (KR)

(21) Appl. No.: 13/608,248

(22) Filed: Sep. 10, 2012

(30) Foreign Application Priority Data
Apr. 2, 2012 (JP) 2012-84146

(51) Int. Cl. B60Q 1/00

(52) U.S. Cl. 362/517

(57) ABSTRACT

A polyhedron type lamp apparatus for a vehicle may include a 3D polyhedron lens having a plurality of outer and inner surfaces facing each other, wherein the outer and inner surfaces may be flat and parallel to each other, at least one mirror surface formed at at least one of the inner surfaces inside the polyhedron lens to reflect light, and at least one semi-mirror surface formed at at least one of the inner surfaces inside the polyhedron lens to divide light into a transmitted light passing light outside the polyhedron lens and a reflected light reflecting light inside the polyhedron lens, wherein a plurality of point light sources may be mounted on at least one of the at least one mirror surfaces and light of the point light sources may be multi-reflected on the at least one mirror surface and the at least one semi-mirror surface.

### CROSS-REFERENCE TO RELATED APPLICATION

The present application claims priority to Japanese Patent Application No. 2012-84146 filed Apr. 2, 2012, the entire contents of which is incorporated herein for all purposes by this reference.

### BACKGROUND OF THE INVENTION

1. Field of the Invention

The present invention relates to a polyhedron type lamp for a vehicle, and more particularly, to a polyhedron type lamp for a vehicle that makes the number of point light sources look like more than the number of actual point light sources and is capable of emitting light like stars in the night sky.

2. Description of Related Art

In general, a light emitting diode (LED) is used as a vehicular lamp. FIG. 16 illustrates an example of a head lamp 10 using a point light source 3 of the LED. Since the LED has a narrow irradiation angle, a plurality of LEDs are disposed on a light emitting surface in order to increase an irradiation area, it increases a cost and power consumption. It is preferable that the light emitting surface is beautifully lightened with a small number of LEDs and visibility is improved not by plane emission but by 3D emission.

A lighting device for a vehicle adopts a lighting device for a vehicle with cubic feeling that has a plurality of LEDs mounted on a reflection surface 3, an inner lens 5 of a translucent mirror disposed in front of the reflection surface 3, and broadens an irradiation range of one LED. However, since a plurality of LEDs as disks with a flat reflection surface are required and the emission surface 3 of the LED and the surface of the inner lens 5 are not particularly parallel to each other, the lighting device is not suitable in that light does not return to the reflection surface 3 but repeatedly multi-reflected even though light is reflected on the inner lens 5.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a polyhedron type lamp for a vehicle that makes the number of point light sources look like more than the number of actual point light sources and is capable of emitting light like stars in the night sky.

In an aspect of the present invention, a polyhedron type lamp apparatus for a vehicle may include a 3D polyhedron lens having a plurality of outer and inner surfaces facing each other, wherein the outer and inner surfaces are flat and parallel to each other, at least one mirror surface formed at at least one of the inner surfaces inside the polyhedron lens to reflect light, and at least one semi-mirror surface formed at at least one of the inner surfaces inside the polyhedron lens to divide light into a transmitted light passing light outside the polyhedron lens and a reflected light reflecting light inside the polyhedron lens, wherein a plurality of point light sources are mounted on at least one of the at least one mirror surfaces and light of the point light sources are multi-reflected on the at least one mirror surface and the at least one semi-mirror surface.

The polyhedron lens is a truncated icosahedron or an oblique rhombicuboctahedron.

The polyhedron lens is mounted on a semi-spherical reflection plate.

According to the polyhedron type lamp for a vehicle, the point light sources can shine more than the number of actual point light sources. Since the polyhedron lens reflects the light of the point light sources to be parallel and among flat surfaces, light is easily reflected without loss. Therefore, the point light sources can shine like the stars in the night sky. A space such as the stars in the night sky that spread ultimately can be expressed. As a result, visibility is improved. Since numerous point light sources are not required it can reduce cost and electricity.

The truncated icosahedron or oblique rhombicuboctahedron is used as the polyhedron lens, a 3D can be obtained, which is constituted by both the outer surface and the inner surface that face each other are parallel to each other and are flat. Since the truncated icosahedron has a soccer ball shape, the truncated icosahedron is suitable for a spherical lamp. The oblique rhombicuboctahedron is suitable for the quadrangular or rectangular lamp.

Since the polyhedron lens is attached to the semi-spherical reflection plate, light emitted through upper and lower and right and left sides is reflected to be condensed in a front direction from the viewpoint of the front of the polyhedron lens.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a polyhedron type lamp for a vehicle using a truncated icosahedron according to an exemplary embodiment of the present invention (various exemplary embodiments).

FIG. 2 is a rear perspective view of the polyhedron type lamp for a vehicle of FIG. 1.

FIG. 3 is a side perspective view of the polyhedron type lamp for a vehicle of FIG. 1.

FIG. 4 is a perspective view of the polyhedron type lamp for a vehicle of FIG. 1 which is turned on.

FIG. 5 is a diagram illustrating a case in which a semi-spherical reflection plate is attached to the polyhedron type lamp of FIG. 1.

FIG. 6 is a front view of the case in which the semi-spherical reflection plate is attached to the polyhedron type lamp of FIG. 1.

FIG. 7 is a front view of a polyhedron type lamp for a vehicle of FIG. 6 which is turned on.

FIG. 8 is a partially enlarged diagram of FIG. 7.

FIG. 9 is a front view of a polyhedron type lamp for a vehicle using an oblique rhombicuboctahedron according to an exemplary embodiment of the present invention (various exemplary embodiments).

FIG. 10 is a side view of the polyhedron type lamp for a vehicle of FIG. 9.

FIG. 11 is a plan view of the polyhedron type lamp for a vehicle of FIG. 9.

FIG. 12 is a perspective view of the polyhedron type lamp for a vehicle of FIG. 9.

FIG. 13 is a diagram illustrating the oblique rhombicuboctahedron of FIG. 9.

FIG. 14 is a diagram illustrating an application example of FIG. 9.

FIG. 15 is a diagram illustrating an application example of FIG. 9.

FIG. 16 is a diagram illustrating an LED head lamp in the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

Hereinafter, a polyhedron type lamp for a vehicle of the present invention will be described with reference to the accompanying drawings.

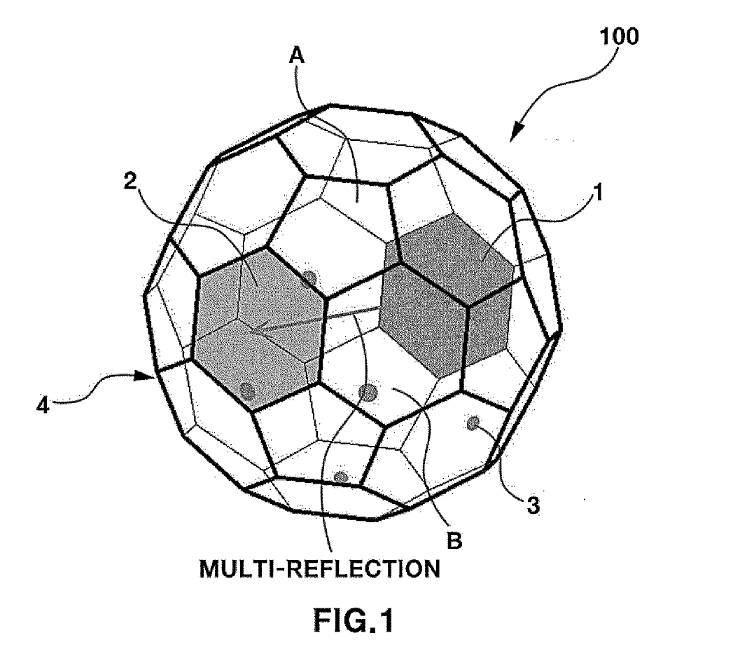

FIG. 1 is a diagram illustrating a polyhedron type lamp 100 for a vehicle according to an exemplary embodiment of the present invention. The polyhedron type lamp 100 for a vehicle uses a truncated icosahedron as a polyhedron lens 4. A 3D of the truncated icosahedron is constituted by 32 surfaces including 20 regular hexagons and 12 regular pentagons. 32 surfaces are formed inside a cavity as well as an outer surface. Surfaces of the regular hexagon represented by mark A is a surface of a top and the surfaces of the regular hexagon represented by mark B is a surface of a bottom. An irradiation direction becomes a direction from mark B to mark A. Point light sources 3 are mounted on 6 surfaces positioned in a counter-irradiation direction inside the polyhedron lens 4. The point light sources 3 are expressed by a black circle. Two regular hexagons (surfaces facing each other) painted light are configured by surfaces which are parallel to each other and flat. Other facing surfaces also have the same relationship. The inner surface with the point light sources 3 is deposited with chrome and is formed by a mirror surface 1 reflecting light. The inner surface without the point light sources 3 is deposited with chrome and is formed by a semi-mirror surface 2 dividing light into a transmitted light passing light outside and reflected light reflecting light inside. The point light sources 3 of the exemplary embodiment are LEDs with high luminance and directionality, but may adopt a small-sized incandescent electric lamp.

As indicated by FIG. 1, since facing surfaces are parallel to each other and flat, some of the transmitted light in the semi-mirror surface 2 are passed outside, while others are reflected from the semi-mirror surface 2 and returned to the mirror surface 1. Then, the returned light is reflected from the mirror surface 1 once again, consequently the light is repeatedly reflected and returned between the mirror surface 1 and the semi-mirror surface 2 to be multi-reflectance.

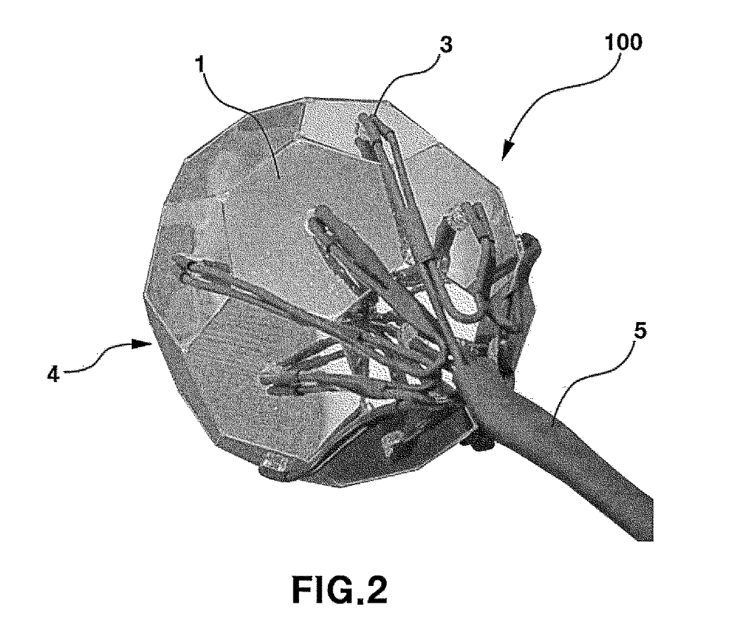

FIG. 2 is a rear perspective view of the polyhedron type lamp 100 for a vehicle. The point light sources 3 are mounted on a wire 5 from the outside in the rear of the polyhedron lens 4. In the exemplary embodiment, total six point light sources 3 are attached onto six surfaces one by one, but are not limited thereto. In the mirror surface 1 indicated by an arrow, an inner surface of the polyhedron lens 4 mounted with the point light sources 3 is formed by the mirror surface.

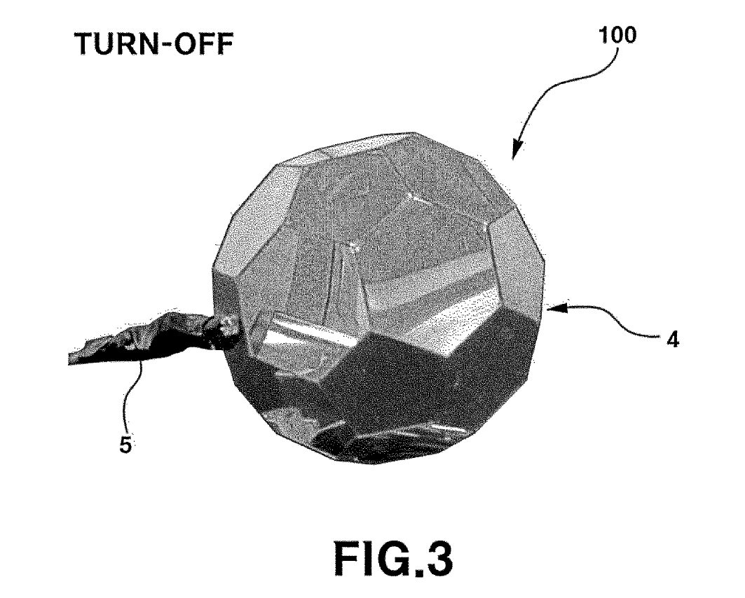

FIG. 3 is a side perspective view of the polyhedron type lamp 100 for a vehicle. A black lower surface of FIG. 3 is a shadow.

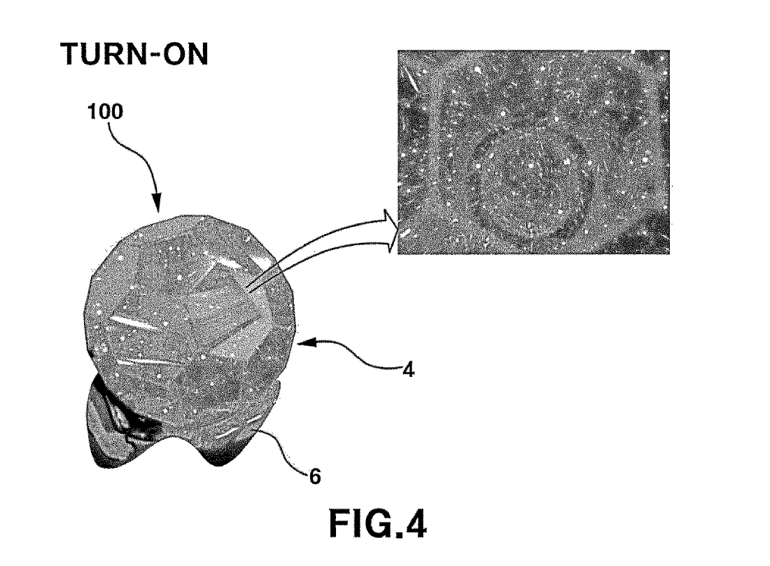

FIG. 4 is a perspective view of the polyhedron type lamp 100 for a vehicle which is turned on. The polyhedron type lamp 100 for a vehicle is laid on an installation mount 6. An enlarged diagram of the polyhedron lens 4 when the point light sources 3 are turned on is shown in an upper right side. Although the number of the mounted point light sources 3 is 6, the point light sources look like more than 6 point light sources. Further, the point light sources shine like stars in the night sky. The point light sources look ultimately enlarged.

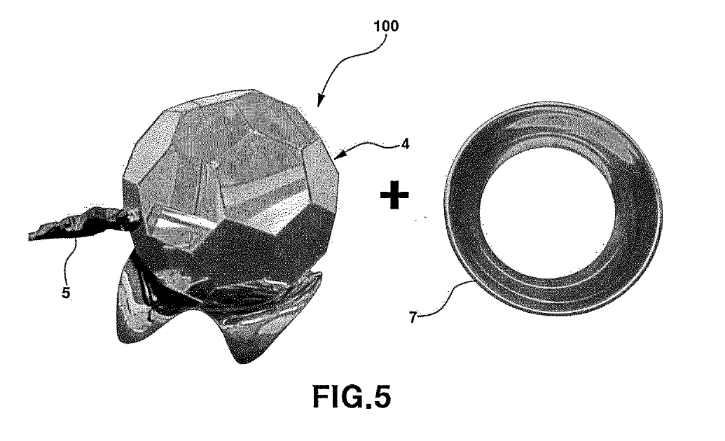

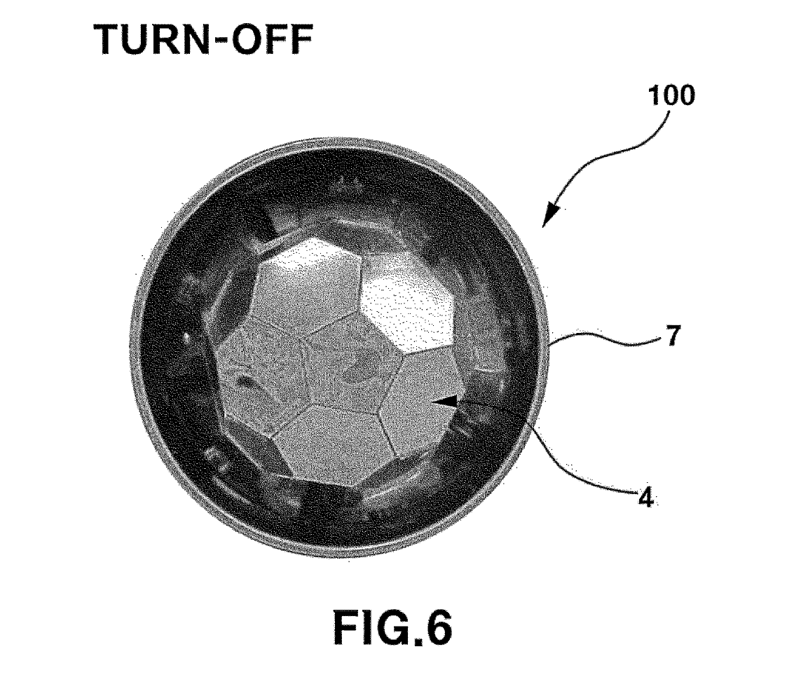

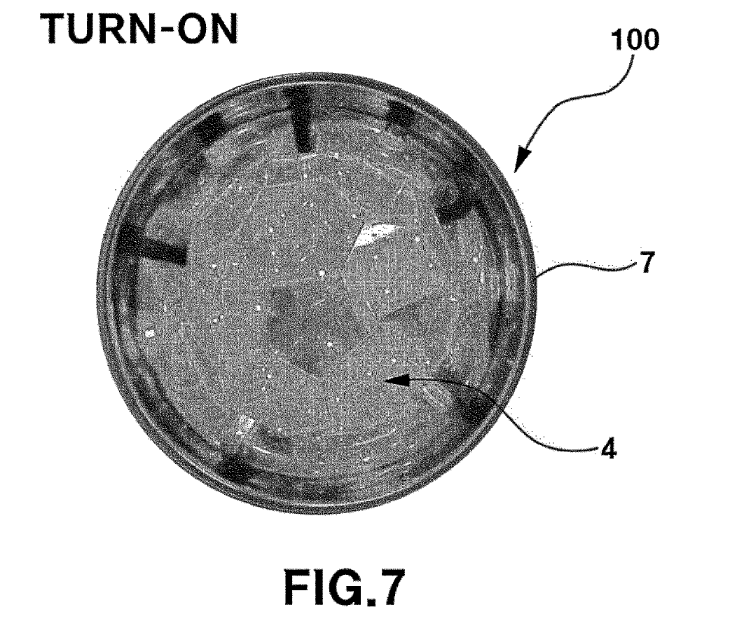

FIG. 5 is a diagram illustrating a case in which a semi-spherical reflection plate 7 is attached to the polyhedron type lamp 100 for a vehicle. The semi-spherical reflection plate 7 is punched because in the rear side thereof the wire 5 of the point light source 3 is installed. FIG. 6 is a front view of the polyhedron type lamp 100 for a vehicle with the semi-spherical reflection plate 7, which is turned off. FIG. 7 is a front view of the polyhedron type lamp 100 for a vehicle with the semi-spherical reflection plate 7, which is turned on.

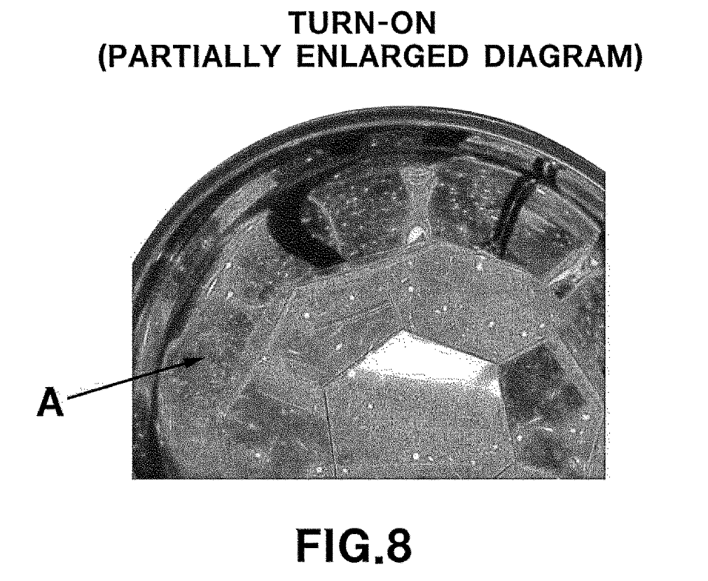

FIG. 8 is a partially enlarged diagram of FIG. 7. As illustrated by mark A of FIG. 8, light emitted from the side to the outside of the polyhedron lens 4 is reflected by the semi-spherical reflection plate 7 to be collected in a front direction (irradiation direction).

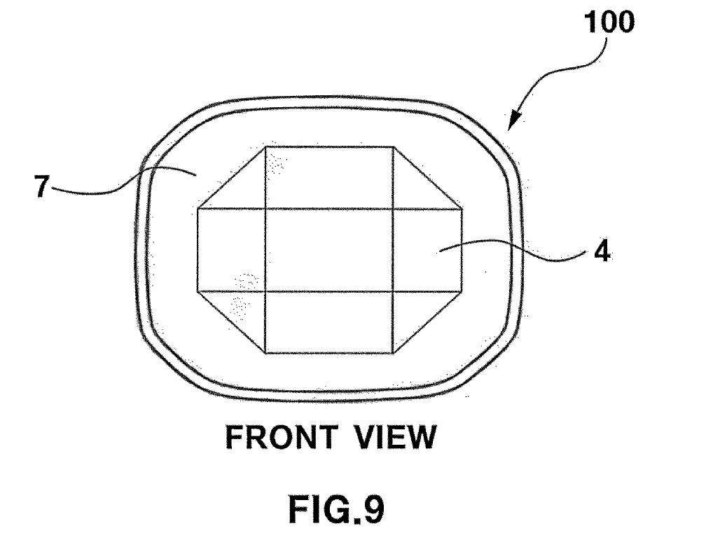

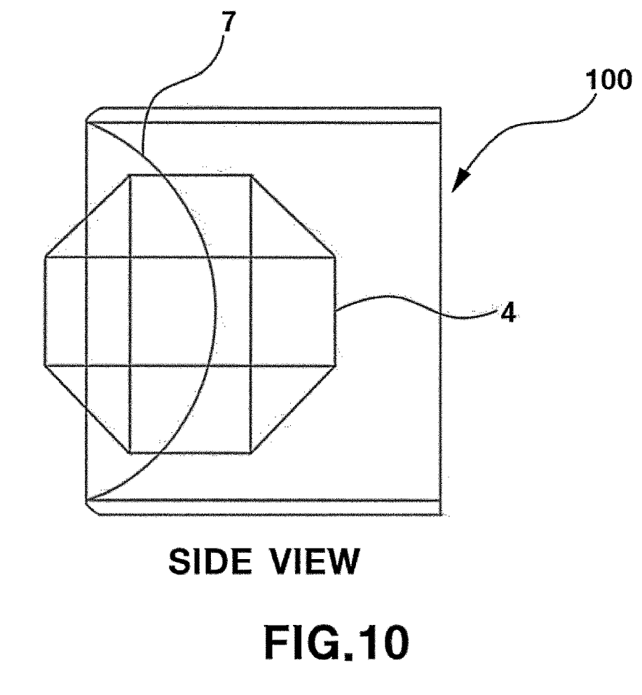

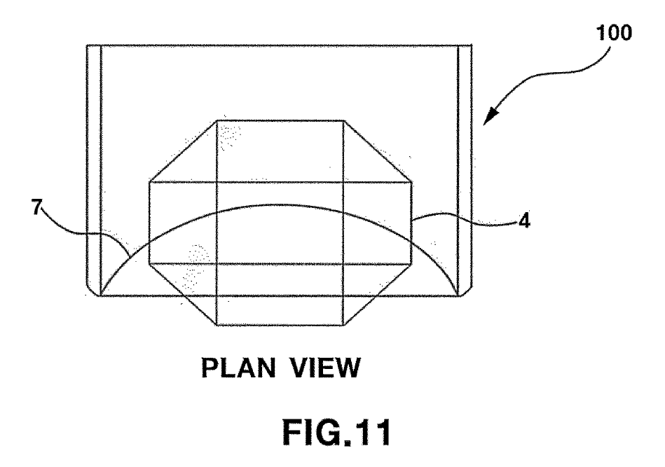

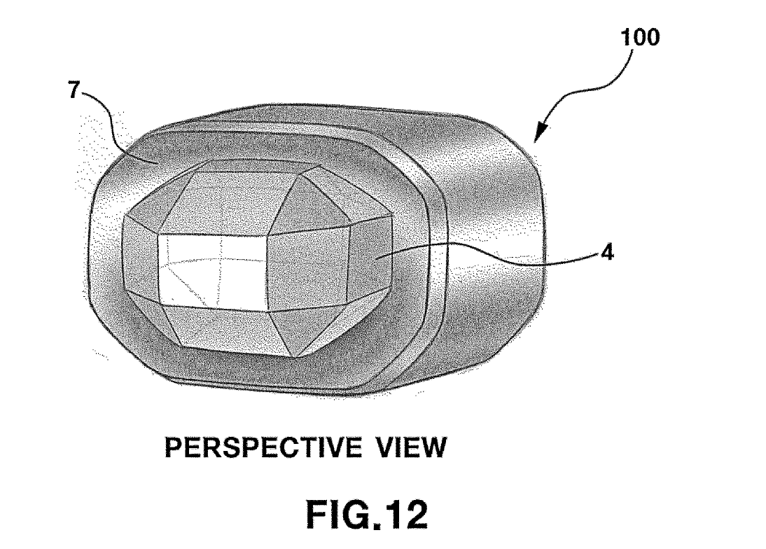

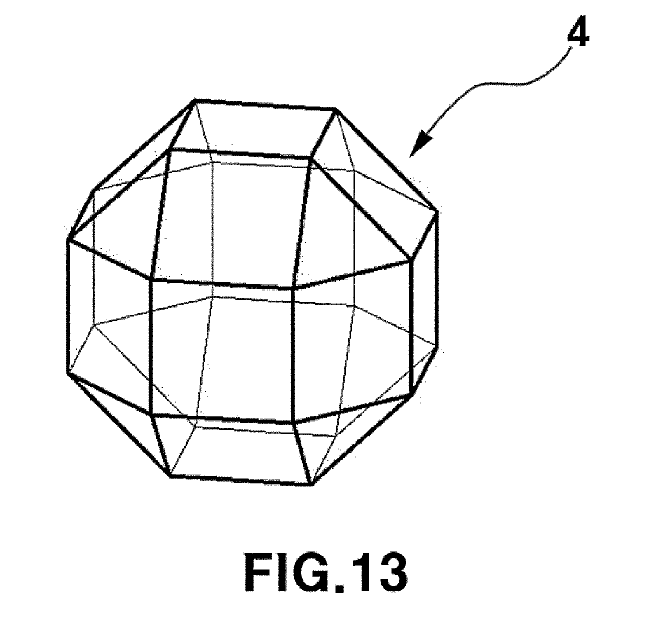

FIGS. 9 to 13 illustrate a polyhedron type lamp 100 for a vehicle using a polyhedron lens 4 unlike the first embodiment. In the second exemplary embodiment, a rhombicuboctahedron is used as the polyhedron lens 4. The polyhedron lens 4 is mounted on the semi-spherical reflection plate 7. As illustrated in FIG. 13, the rhombicuboctahedron is constituted by 8 regular triangles and 18 quadrangles, but the rhombicuboctahedron has a forward-backward pressed shape as illustrated in FIGS. 9 to 12.

In the shape, surfaces facing each other are parallel to each other and flat. 26 surfaces are formed inside the cavity as well as the outer surface. 5 quadrangles and 4 triangles on one side of an oblique rhombicuboctahedron are formed as the mirror surface to be attached with the point light sources. Other surfaces are formed as semi-mirror surfaces. The mirror surface and the semi-mirror surface may be formed by chrome deposition. Although 9 point light sources are used in this configuration, the point light sources may shine like the stars in the night sky, as if there are a large number of point light sources, as in FIG. 4.

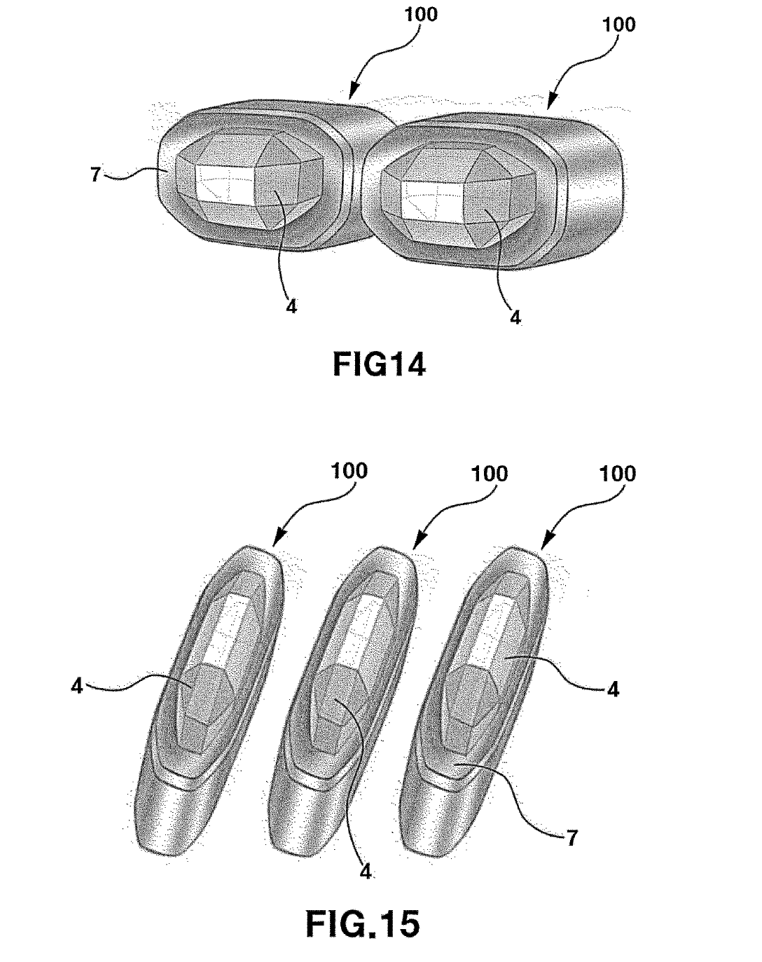

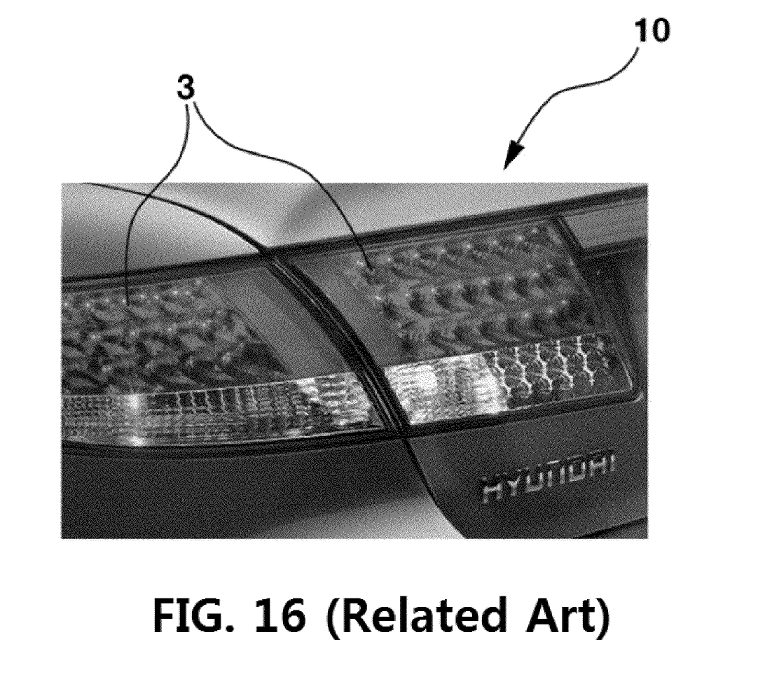

FIGS. 14 and 15 illustrate application examples of the polyhedron type lamp 100 for a vehicle of the second exemplary embodiment. As illustrated in FIG. 14, two polyhedron type lamps may be combined and mounted on the vehicle. As illustrated in FIG. 15, while the polyhedron lens 4 is transformed to a rectangle, the plurality of polyhedron lenses 4 may be placed obliquely.

The polyhedron type lamp 100 for a vehicle of the present invention may be used for a stop lamp, a turn signal lamp of a back lamp, and a room lamp of the vehicle in addition to a head lamp. Further, the polyhedron type lamp 100 for a vehicle is not limited thereto and may be used for even an indoor lighting lamp (furniture), a signaler, an illumination signboard, or an amusement machine (pachinko, and the like).

Due to the reduction in resources and power consumption and excellent visibility, the present invention is very suitable as the polyhedron type lamp for a vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A polyhedron type lamp apparatus for a vehicle, comprising:
a 3D polyhedron lens having a plurality of outer and inner surfaces facing each other, wherein the outer and inner surfaces are flat and parallel to each other;
at least one mirror surface formed at at least one of the inner surfaces inside the polyhedron lens to reflect light; and
at least one semi-mirror surface formed at at least one of the inner surfaces inside the polyhedron lens to divide light into a transmitted light passing light outside the polyhedron lens and a reflected light reflecting light inside the polyhedron lens,
wherein a plurality of point light sources are mounted on at least one of the at least one mirror surfaces and light of the point light sources are multi-reflected on the at least one mirror surface and the at least one semi-mirror surface.

2. The polyhedron type lamp apparatus for the vehicle of claim 1, wherein the polyhedron lens is a truncated icosahedron or an oblique rhombicuboctahedron.

3. The polyhedron type lamp apparatus for the vehicle of claim 1, wherein the polyhedron lens is mounted on a semi-spherical reflection plate.
